(19) United States
(12) Patent Application Publication
(10) Pub. No.: US 2013/0343047 A1
(43) Pub. Date: Dec. 26, 2013

(54) STROBE DEVICE

(71) Applicants: Toshiaki Murai, Osaka (JP); Yasushi Ogino, Kyoto (JP); Hiroshi Saiki, Kyoto (JP); Katsunori Kawabata, Kyoto (JP); Satoshi Amari, Hyogo (JP)

(72) Inventors: Toshiaki Murai, Osaka (JP); Yasushi Ogino, Kyoto (JP); Hiroshi Saiki, Kyoto (JP); Katsunori Kawabata, Kyoto (JP); Satoshi Amari, Hyogo (JP)

(73) Assignee: PANASONIC CORPORATION, Osaka (JP)

(21) Appl. No.: 14/003,256

(22) PCT Filed: Mar. 7, 2012
(86) PCT No.: PCT/JP2012/001548

§ 371 Date: Sep. 5, 2013

(30) Foreign Application Priority Data
Mar. 16, 2011 (JP) 2011057509

(51) Int. Cl. F21V 17/10; F21V 7/00

(52) U.S. Cl. CPC F21V 17/10; F21V 7/005
USPC 362/217.05

(57) ABSTRACT

A strobe device of the present invention includes a cylindrical flashtube, a reflector for reflecting light coming from the flashtube, a trigger circuit for applying a trigger voltage to the reflector, and a conductive abutting section that is disposed on at least one of the flashtube and reflector and abuts on at least the other of the flashtube and reflector. The conductive abutting section is disposed in the axial direction of the flashtube. Thus, a strobe device that generates light of stable brightness can be achieved.

This application is a U.S. National Phase Application of PCT International Application PCT/JP2012/001548.

### TECHNICAL FIELD

The present invention relates to a strobe device for emitting light by applying a trigger voltage to a flashtube via a reflector.

### BACKGROUND ART

Conventionally, there are a strobe device integrally mounted on an apparatus such as a digital still camera or a mobile phone, and a strobe device to be attached to the apparatus. Each of these strobe devices includes a cylindrical flashtube and a reflector for reflecting the light emitted from the flashtube toward a subject.

Generally, the flashtube includes electrode terminals that are sealed to both ends of a cylindrical glass bulb extending in one direction as the longitudinal direction, and a glass bulb filled with rare gas.

The flashtube applies a trigger voltage to the outer periphery of the glass bulb while supplying electric power to the electrode terminals at both ends, thereby exciting the rare gas in the glass bulb.

Such a strobe device, generally, has a configuration that a trigger voltage is applied to a conductive film formed on the outer peripheral surface of the glass bulb of the flashtube. However, when the conductive film is disposed on the whole or a part of the outer peripheral surface between the electrodes of the glass bulb, light generated in the flashtube is absorbed by the conductive film, and hence the light quantity during light emission decreases, disadvantageously.

Therefore, a strobe device capable of applying a trigger voltage to a flashtube without forming, on the outer peripheral surface of the glass bulb, a conductive film that causes reduction in light quantity is disclosed (for example, Patent Literature 1).

The strobe device includes a reflector that is formed by bending a conductive plate so as to form a recessed (concaved) bent surface and uses the bent surface as the reflecting surface. The reflector has a recessed strip section in the center part (center part in the bent direction) of the bent reflecting surface, and allows the glass bulb of the flashtube to be inserted into the recessed strip section. By inserting the glass bulb of the flashtube into the recessed strip section of the reflector, the inner surface of the recessed strip section is brought into surface contact with the outer peripheral surface of the glass bulb.

The strobe device having this configuration applies a trigger voltage to the reflector, thereby applying the trigger voltage to the region that is in surface contact with the inner surface of the recessed strip section, of the outer peripheral surface of the glass bulb of the flashtube, and emitting light in the flashtube. Thus, a strobe device is achieved which prevents the light generated in the flashtube from being absorbed by a conductive film and can reflect much light on the reflecting surface of the reflector and irradiate a subject.

The conventional strobe device of Patent Literature 1, however, has a problem where the brightness of the light emitted to a subject fluctuates for the following reason.

Specifically, a different position in the region to which a trigger voltage is applied becomes the origin of light emission (hereinafter referred to as “light emission point”) for each light emission. In other words, if the inner surface of the recessed strip section of the reflector is brought into surface contact with the outer peripheral surface of the bulb, the flashtube emits light at a nonspecific position in a large region that undergoes the surface contact when the trigger voltage is applied. Therefore, when the flashtube emits light at different circumferential positions of the glass bulb as light emission points, the positional relationship between the light emission points and the reflecting surface of the reflector varies. As a result, the reflecting direction on the reflecting surface of the reflector of the light generated in the flashtube varies, and a certain quantity of light cannot be emitted to a subject, disadvantageously.

Especially, when a small quantity of light is generated by the strobe device having the above-mentioned configuration, the light emission points are localized. As a result, the positions of the light emission points at which light is generated are apt to vary, and fluctuation in brightness of the light emitted to a subject becomes remarkable.

### CITATION LIST

### Patent Literature

PTL 1 Examined Japanese Utility Model Publication No. H04-55312

### SUMMARY OF THE INVENTION

In order to address the above-mentioned problems, a strobe device of the present invention includes the following elements:
a cylindrical flashtube;
a reflector for reflecting light coming from the flashtube;
a trigger circuit for applying a trigger voltage to the reflector; and
a conductive abutting section that is disposed on at least one of the flashtube and reflector and abuts on at least the other of the flashtube and reflector.
   The conductive abutting section is disposed in the axial direction of the flashtube.

Thus, it can be prevented that light is generated at a different circumferential position (light emission point) of the flashtube for each light emission. Therefore, a strobe device that can emit light of stable brightness to a subject can be achieved.

### BRIEF DESCRIPTION OF DRAWINGS

FIG. 1 is a schematic perspective view of a strobe device in accordance with an exemplary embodiment of the present invention.

FIG. 2A is a schematic front view of the strobe device in accordance with the exemplary embodiment of the present invention.

FIG. 2B is a sectional view taken in line 2B-2B of the strobe device of FIG. 2A.

FIG. 3A is a schematic front view of another strobe device in accordance with the exemplary embodiment of the present invention.

FIG. 3B is a sectional view taken in line 3B-3B of the strobe device of FIG. 3A.

FIG. 4A is a schematic front view of yet another strobe device in accordance with the exemplary embodiment of the present invention.

FIG. 4B is a sectional view taken in line 4B-4B of the strobe device of FIG. 4A.

### DESCRIPTION OF EMBODIMENTS

A strobe device of an exemplary embodiment of the present invention will be described hereinafter with reference to the accompanying drawings. In the following description, the same or corresponding elements are denoted with the same reference marks.

### Exemplary Embodiment

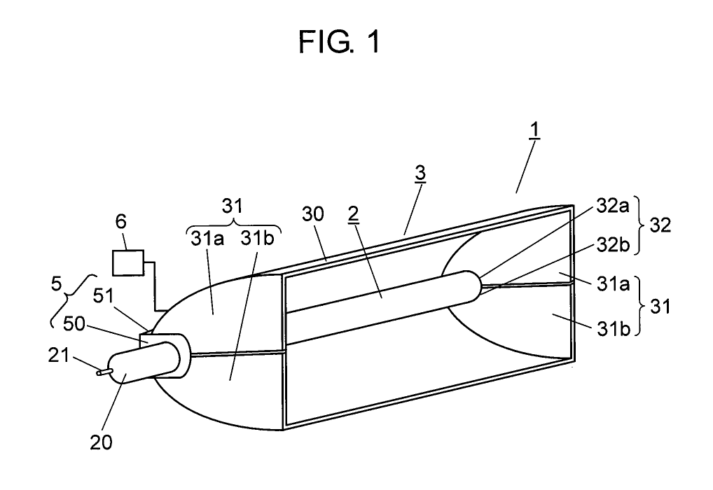

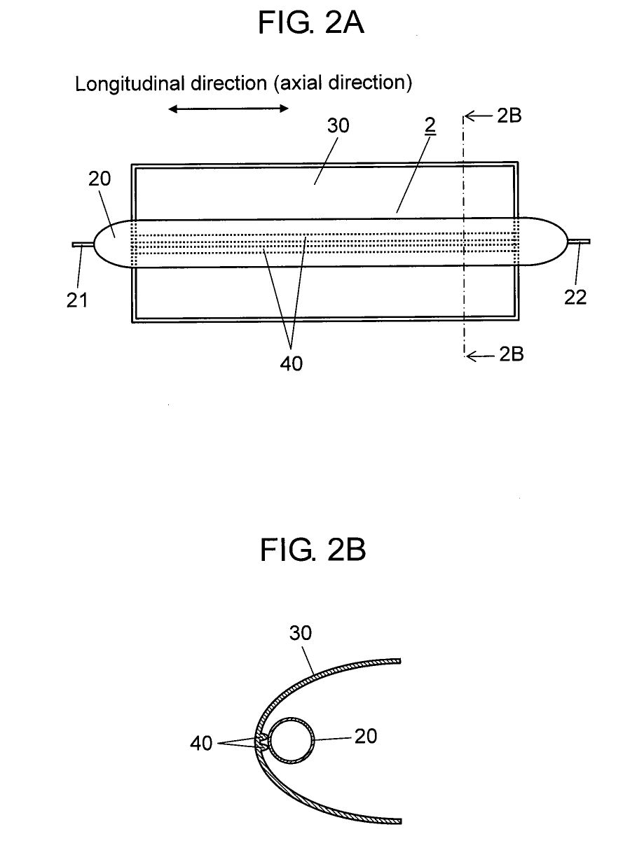

A strobe device of an exemplary embodiment of the present invention will be described hereinafter using FIG. 1 through FIG. 2B.

FIG. 1 is a schematic perspective view of a strobe device in accordance with an exemplary embodiment of the present invention. FIG. 2A is a schematic front view of the strobe device in accordance with the exemplary embodiment of the present invention. FIG. 2B is a sectional view taken in line 2B-2B of the strobe device of FIG. 2A.

As shown in FIG. 1, strobe device 1 of the present exemplary embodiment includes at least flashtube 2, reflector 3, and trigger circuit 6. Flashtube 2 is fixed on reflector 3 via fixing section 5. Trigger circuit 6 applies a trigger voltage to flashtube 2 via reflector 3. Reflector 3 has a shape that is specifically described later, houses flashtube 2, and reflects light generated from flashtube 2.

Flashtube 2 includes the following elements:
glass bulb 20 that is formed in a cylindrical shape extending in one direction, namely in the longitudinal direction, and is made of a glass material mainly containing silicon dioxide, for example; and
electrode terminal sections 21 and 22 that are sealed to both ends of glass bulb 20 and are made of tungsten, for example.
   Rare gas such as xenon is filled into glass bulb 20.

Hereinafter, the shape and structure of reflector 3 are specifically described.

Reflector 3 is formed in a predetermined shape by press-molding a metal plate made of a high-reflectivity metal material or the like containing aluminum as a base material, for example.

Specifically, as shown in FIG. 1, reflector 3 includes reflecting section 30, and sidewalls 31 for closing the ends on the electrode terminal sides of reflecting section 30. Reflecting section 30 is formed in the axial direction of glass bulb 20 in a state where it is bent so as to face a circumferential predetermined range of glass bulb 20. Each of sidewalls 31 formed on both ends of reflecting section 30 includes a pair of sidewall sections 31a and 31b, and sidewall sections 31a and 31b are arranged vertically in side view and are connected to each of the longitudinal ends of reflecting section 30.

Opening 32 into which flashtube 2 can be inserted is disposed in a part where sidewall sections 31a and 31b of sidewall 31 face each other, and is formed of semicircular notches 32a and 32b, for example.

As shown in FIG. 2A and FIG. 2B, conductive abutting section 40 for electrically connecting flashtube 2 to reflector 3 is integrally formed on reflecting section 30 of reflector 3 by press molding or the like. At this time, conductive abutting section 40 is linearly and continuously formed at least in the longitudinal direction of reflecting section 30.

Conductive abutting section 40 is projected on the reflecting surface side (the side of the surface for reflecting light of flashtube 2) of reflecting section 30 of reflector 3, and the tip of conductive abutting section 40 abuts on flashtube 2.

In the present exemplary embodiment, as shown in FIG. 2A, conductive abutting section 40 having two strips, for example, is extended linearly in the axial direction of flashtube 2 (longitudinal direction of reflecting section 30).

Thus, conductive abutting section 40 is abutted on flashtube 2 linearly in the axial direction of flashtube 2.

As shown in FIG. 1, fixing section 5 includes the following elements:
a pair of insertion sections 50 into which the ends of glass bulb 20 of flashtube 2 can be inserted and which are disposed outside sidewalls 31 at the ends of reflecting section 30; and
connecting section 51 that interconnects the pair of insertion sections 50.
   Connecting section 51 is made of an elastic material such as rubber.

The pair of insertion sections 50 are pulled by connecting section 51 to the reflecting surface side (the side abutting on conductive abutting section 40) of reflecting section 30 in the state where the ends of flashtube 2 are inserted into insertion sections 50. Thus, the outer peripheral surface of glass bulb 20 of flashtube 2 is fixed to reflecting section 30 in a pressed state on conductive abutting section 40.

Strobe device 1 having the above-mentioned configuration excites rare gas to emit light by applying a trigger voltage from trigger circuit 6 to flashtube 2 via reflector 3 and conductive abutting section 40.

Hereinafter, the operation of emitting light from flashtube 2 in strobe device 1 of the present exemplary embodiment is described.

First, to electrode terminal sections 21 and 22 that are bonded to both ends of glass bulb 20 of flashtube 2, electric power is supplied from a capacitor charged by an external charging circuit (not shown), for example. Simultaneously, a trigger voltage is applied from trigger circuit 6 to reflector 3. The trigger voltage having been applied to reflector 3 is applied to flashtube 2 via the region that is in contact with conductive abutting section 40, on the outer peripheral surface of glass bulb 20.

Thus, the rare gas filled into glass bulb 20 of flashtube 2 is excited by the trigger voltage to emit light. At this time, a specific position of the outer peripheral surface of glass bulb 20 is in contact with conductive abutting section 40, and the trigger voltage is applied to conductive abutting section 40, so that the positional variation of the light emission point to emit light can be suppressed.

When the time period in which the trigger voltage is applied is extended, the light generating region in flashtube 2 can be enlarged. Therefore, light of a large light quantity can be generated.

When the time period in which the trigger voltage is applied is shortened, the light generating region in flashtube 2 can be reduced. Therefore, light of a small light quantity can be generated.

Thus, in strobe device 1 of the present exemplary embodiment, the tips of conductive abutting section 40 are made to abut on flashtube 2 linearly in the axial direction, thereby preventing light from being generated at a circumferential nonspecific position of glass bulb 20. Thus, even when light of a small light quantity is generated, it can be prevented that light is generated at a different circumferential position of flashtube 2 for each light emission, and a light emission point to emit light can be formed in a predetermined range near conductive abutting section 40, which is in contact with flashtube 2. As a result, a strobe device can be achieved which can irradiate a subject with light that has small fluctuation in brightness and has stable brightness.

The strobe device of the present invention is not limited to the present exemplary embodiment. The strobe device can be modified as long as it does not go out of the scope of the present invention, as a matter of course.

In other words, the present exemplary embodiment has described the example where conductive abutting section 40 having two strips is disposed on the reflecting surface side of reflecting section 30. The present invention is not limited to this. For example, conductive abutting section 40 may have one strip. In this case, a low-cost strobe device having high moldability and high productivity can be achieved. Conductive abutting section 40 may have three or more strips as long as the strips can abut on the outer peripheral surface of the glass bulb. In this case, stability in connection between reflecting section 30 and glass bulb 20 can be improved.

The present exemplary embodiment has described the example where conductive abutting section 40 is linearly and continuously disposed on reflecting section 30 of reflector 3 at least in the longitudinal direction of reflecting section 30. The present invention is not limited to this. For example, conductive abutting section 40 may be disposed on reflecting section 30 of reflector 3 linearly and intermittently at least in the longitudinal direction of reflecting section 30. In this case, stable light emission can be kept by preferentially adjusting and disposing conductive abutting section 40 in a place where the position of the light emission point is apt to vary in the longitudinal direction of flashtube 2, for example. Furthermore, conductive abutting section 40 may be disposed on reflecting section 30 of reflector 3 intermittently in a staggered pattern at least in the longitudinal direction of reflecting section 30. In this case, the stability in connection between reflecting section 30 and glass bulb 20 can be improved.

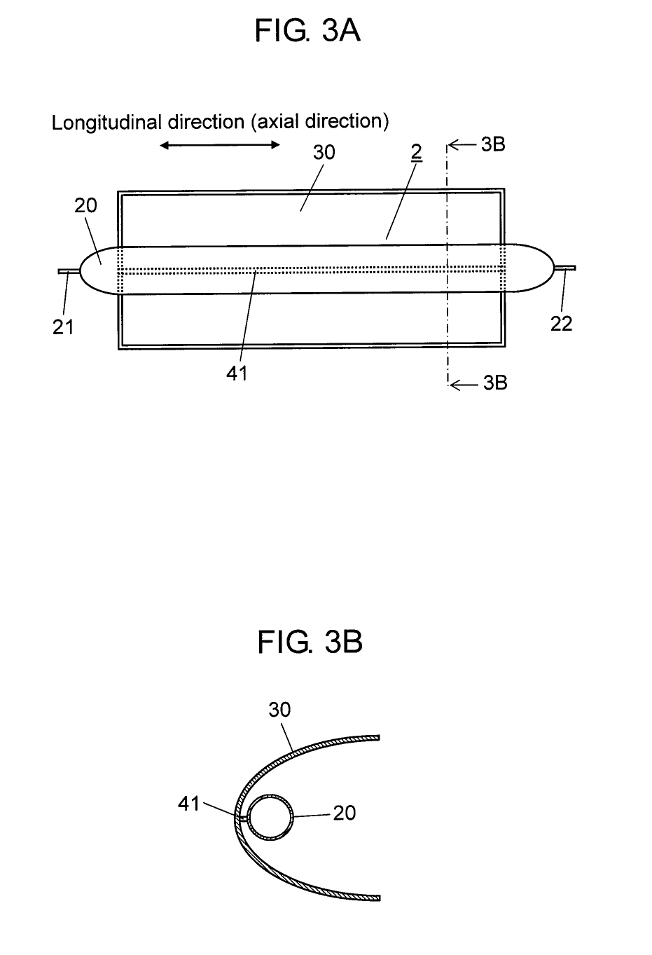

The present exemplary embodiment has described the example where conductive abutting section 40 is integrally disposed on reflecting section 30 of reflector 3. The present invention is not limited to this. Conductive abutting section 40 may be formed separately from reflecting section 30, as described below using FIG. 3A and FIG. 3B.

FIG. 3A is a schematic front view of another strobe device in accordance with the exemplary embodiment of the present invention. FIG. 3B is a sectional view taken in line 3B-3B of the strobe device of FIG. 3A.

As shown in FIG. 3A and FIG. 3B, using an adhesive or the like, conductive abutting section 41 that is formed separately from reflecting section 30 and has a linear shape, for example, is bonded on the reflecting surface side of reflecting section 30 or the outer peripheral surface of glass bulb 20. Then, reflecting section 30 may be abutted on and connected to flashtube 2 via fixing section 5 of FIG. 1, further via conductive abutting section 41. In this case, the structure of reflecting section 30 can be simplified. As a result, a low-cost strobe device of high productivity can be achieved.

The following configuration may be employed:
conductive abutting section 41 having two strips, for example, is formed separately, one of the strips is bonded to reflecting section 30, and the other is bonded to glass bulb 20, is disposed as shown in FIG. 2A, for example, and is abutted on and connected to reflecting section 30.
   In this case, reflecting section 30 and glass bulb 20 can be stably interconnected via the conductive abutting section having two strips. As a result, a strobe device that stably emits light and has high reliability can be achieved. At this time, the conductive abutting section is bonded to glass bulb 20 or reflecting section 30 using a conductive adhesive, as a matter of course.

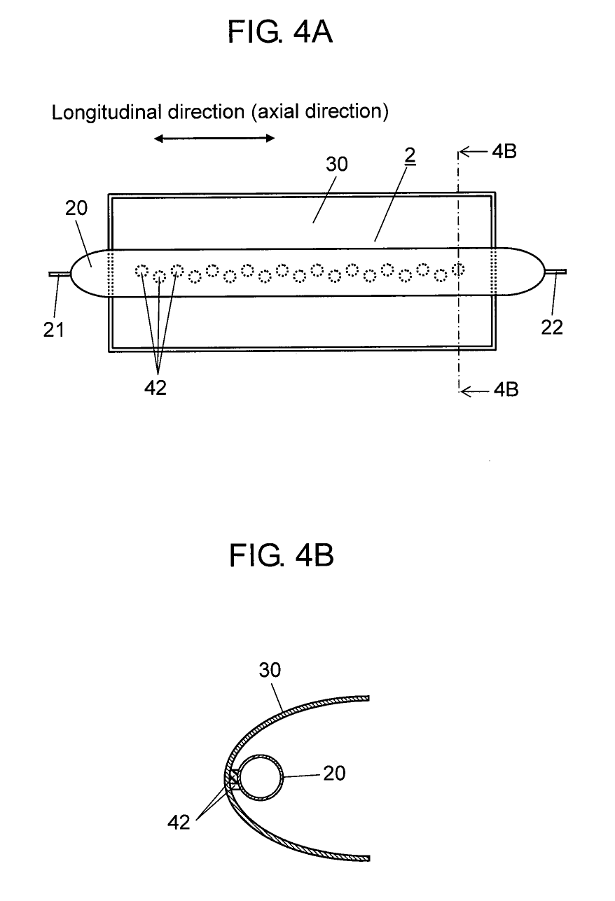

The present exemplary embodiment has described the example where linear conductive abutting section 40 is integrally formed on reflecting section 30 by press molding. The present invention is not limited to this. For example, a plurality of conductive abutting sections 42 having the same protrusion shown in FIG. 4A may be integrally formed on reflecting section 30 by press molding. Furthermore, as described below using FIG. 4A and FIG. 4B, conductive abutting sections 42 may be formed separately from reflector 3. Thus, conductive abutting sections 42 having the protrusion can be disposed in a place where the position of the light emission point is apt to vary in the longitudinal direction of flashtube 2 while the number of conductive abutting sections 42 is adjusted. As a result, a strobe device capable of keeping stable light emission can be achieved.

FIG. 4A is a schematic front view of yet another strobe device in accordance with the exemplary embodiment of the present invention. FIG. 4B is a sectional view taken in line 4B-4B of the strobe device of FIG. 4A.

As shown in FIG. 4A and FIG. 4B, conductive abutting sections 42 that are formed separately from reflecting section 30 are bonded on the reflecting surface side of reflecting section 30 or the outer peripheral surface of glass bulb 20, using a conductive adhesive or the like. Then, reflecting section 30 may be butted on and connected to flashtube 2 via fixing section 5 of FIG. 1, further via conductive abutting sections 42. Conductive abutting sections 42 may be bonded to both the reflecting surface side of reflecting section 30 and glass bulb 20. In this case, conductive abutting sections 42 having the protrusion can be disposed in a place where the position of the light emission point is apt to vary in the longitudinal direction of flashtube 2 while the number of conductive abutting sections 42 is adjusted. As a result, a strobe device capable of keeping stable light emission can be achieved.

The strobe device of the present invention includes the following elements:
a cylindrical flashtube;
a reflector for reflecting light coming from the flashtube;
a trigger circuit for applying a trigger voltage to the reflector; and
a conductive abutting section that is disposed on at least one of the flashtube and reflector and abuts on at least the other of the flashtube and reflector.
   The conductive abutting section is disposed in the axial direction of the flashtube.

In this configuration, the flashtube is connected to the reflector via the conductive abutting section. Thus, when a trigger voltage is applied to the reflector, the trigger voltage is applied to the region that is in contact with the conductive abutting section, on the outer peripheral surface of the flashtube, and the flashtube emits light.

The flashtube is in contact with the conductive abutting section in the axial direction of the flashtube. In other words, in the strobe device, a part of the flashtube that is in contact with the conductive abutting section is distributed in the axial direction.

Thus, it can be prevented that light is generated at a different circumferential position (light emission point) of the flashtube for each light emission. As a result, a strobe device capable of irradiating a subject with light of stable brightness can be achieved.

The strobe device of the present invention is disposed continuously in the axial direction of the flashtube. Thus, the rate of occurrence of a light emission failure caused by a contact failure can be reduced.

The strobe device of the present invention, the reflector is molded of a metal plate, and the conductive abutting section is formed linearly in the axial direction of the flashtube in a projecting state on the reflecting surface side of the reflector.

Thanks to this configuration, the flashtube can be brought into contact with the conductive abutting section linearly in the axial direction of the flashtube. Thus, it can be prevented that light is generated at a different circumferential position (light emission point) of the flashtube for each light emission. As a result, a strobe device capable of irradiating a subject with light of stable brightness can be achieved.

In the strobe device of the present invention, the conductive abutting section includes a plurality of protrusions, and the protrusions are disposed discretely in the axial direction of the flashtube between the reflecting surface of the reflector and the flashtube.

Thanks to this configuration, the flashtube can be brought into contact with the conductive abutting section discretely formed in the axial direction of the flashtube. Thus, it can be prevented that light is generated at a different circumferential position (light emission point) of the flashtube for each light emission. As a result, a strobe device capable of irradiating a subject with light of stable brightness can be achieved.

### INDUSTRIAL APPLICABILITY

The strobe device of the present invention is applicable to a mobile device such as a digital still camera or a mobile phone demanding that light having stable brightness is generated regardless of light quantity.

### REFERENCE MARKS IN THE DRAWINGS

1 strobe device
2 flashtube
3 reflector
5 fixing section
6 trigger circuit
20 glass bulb
21, 22 electrode terminal section
30 reflecting section
31 sidewall
31a, 31b sidewall section
32 opening
32a, 32b notch
40 conductive abutting section
41 conductive abutting section
42 conductive abutting section
50 insertion section
51 connecting section

1. A strobe device comprising:
a cylindrical flashtube;
a reflector for reflecting light coming from the flashtube;
a trigger circuit for applying a trigger voltage to the reflector; and
a conductive abutting section disposed on at least one of the flashtube and the reflector, the conductive abutting section abutting on at least the other of the flashtube and the reflector,
wherein the conductive abutting section is disposed in an axial direction of the flashtube.

2. The strobe device of claim 1, wherein
the conductive abutting section is disposed continuously in the axial direction of the flashtube.

3. The strobe device of claim 1, wherein
the conductive abutting section is disposed intermittently in the axial direction of the flashtube.

4. The strobe device of claim 1, wherein
the reflector is molded of a metal plate, and
the conductive abutting section is formed linearly in the axial direction of the flashtube in a projecting state on a reflecting surface side of the reflector.

5. The strobe device of claim 1, wherein
the conductive abutting section includes a plurality of protrusions, and
the protrusions are disposed discretely in the axial direction of the flashtube between a reflecting surface of the reflector and the flashtube.
